(19) United States
(12) Patent Application Publication
(10) Pub. No.: US 2024/0278258 A1
(43) Pub. Date: Aug. 22, 2024

(54) JIG CONCENTRATOR

(71) Applicants: Richard Snoby, Dahlonega, GA (US); Andrew Snoby, Dahlonega, GA (US)

(72) Inventors: Richard Snoby, Dahlonega, GA (US); Andrew Snoby, Dahlonega, GA (US)

(21) Appl. No.: 18/653,471

(22) Filed: May 2, 2024

Related U.S. Application Data
(63) Continuation of application No. 17/486,718, filed on Sep. 27, 2021, now abandoned.
Application No. 17/486,718 is a continuation of application No. PCT/US2020/025538, filed on Mar. 27, 2020.
(60) Provisional application No. 62/824,435, filed on Mar. 27, 2019.

(51) Int. Cl. B03B 5/22; B03B 5/24

(52) U.S. Cl. CPC B03B 5/22; B03B 5/24

(57) ABSTRACT

A jig concentrator includes a jigging bed with a plurality of holes, a flow control valve associated with the jigging bed to regulate the flow of fluid, and a pulsation housing connected to the flow control valve to control the pulsation of water or another medium. The flow control valve is located beneath the bed. A water or fluid inlet is connected to the pulsation housing to introduce water into the apparatus, and a pressurized air buffer is mounted on the water inlet to buffer and store air in the jig concentrator.

### CROSS REFERENCE TO RELATED APPLICATIONS

This application is a continuation-in-part of U.S. patent application Ser. No. 17/486,718, filed on Mar. 27, 2020, which is a continuation of International Patent Application No. PCT/US2020/025538, which claims the benefit of U.S. Provisional Application No. 62/824,435, filed on Mar. 27, 2019, each of which is incorporated by reference herein in its entirety.

### TECHNICAL FIELD

This application relates to material separation and equipment for material separation.

### BACKGROUND

Jigging, including wet jigging, has been a technique used for centuries to separate materials. Traditional jigs use a jig tank with open top and bottom ends. Materials delivered to the jig may be pre-sized to prevent oversized or undersized particles from entering the jig tank, using perforated screens. They can flow down a portion of the chute for discharge from the jig. In the upper part of the jig tank, a material support device, like a perforated screen plate or other similar supports with multiple holes, holds the material to be jigged, allowing fluid to pulse through it. The material, often ore containing light and heavy particles (distinguished by specific gravity), is moved from the feed to the discharge end of the jig by water pulsation or by a combination of pulsation and additional material delivery.

A grate may be placed on top of the material support to serve as a containment grid for the ragging material. Water pulsation within the jig lifts the ragging above the screen, creating a dilation in the material bed. This causes the particles in the bed to become suspended. Heavier particles within the bed move downward into the ragging and eventually pass through the screen. These particles settle in the tank until they can exit through a valve at the bottom.

A jig serves two main purposes: stratifying material by density and then separating it. Jigging to stratify particles by their density involves four primary actions or phases. First, differential acceleration occurs due to the initial upward pulsation of the jigging fluid, accelerating smaller, lighter particles faster and higher than coarser, denser ones. Second, in the free settling velocity phase, larger, denser particles begin to fall sooner and faster. The third phase, hindered settling, happens when the jig bed shrinks, causing particles to bump into each other, preventing larger, low-density particles from falling through the stratified bed. Lastly, in the consolidated trickling phase, very small, high-density particles are drawn to the lower levels of the stratified bed during the suction stroke. Light and heavy particles can be separated based on their ability to penetrate an oscillating fluid bed supported on a screen. Additionally, separation can be achieved by measuring the interface between light and heavy particle layers and removing heavy particles from the lower jig bed using mechanical devices like valves, star gates, vibrating feeders, and other known devices.

Jigging experts recognize that a pulsating fluid current, such as water, can be created using a plunger, mechanical lever, air injection, flexible diaphragm, or other mechanisms to dilate and collapse a particle mixture. Each system has its benefits and limitations. Mechanical systems experience wear and eventual failure, while air-based systems require additional space to accommodate the air needed for optimized particle stratification by density. Efficient stratification allows for the more effective separation of particles, which is the jig's second primary function.

Accordingly, there is an ongoing need for improved jigs or jig concentrators. This application is directed to these needs among others.

### SUMMARY

This application presents a jig or jig concentrator designed to separate heavy and light particles from materials with varying specific gravities. In one example, the jig effectively separates heavy and light particles from ores and minerals. The jig is suitable for materials that are traditionally separated using a jig or density separator.

One embodiment includes a jig or jig concentrator apparatus featuring a bed or jigging bed that stratifies and separates heavy and light particles more efficiently over a wider area compared to current technology, resulting in increased capacity. The jig bed supports the material while allowing water to flow through its holes, creating pulsation and suction strokes. The jig's width is increased by introducing water directly beneath the jigging bed. A flow control valve associated with the jigging bed regulates the flow of fluid, restricting the flow per unit of time to set the amplitude of the jigging stroke. A pulsation housing connected to the flow control valve manages water pulsation and determines the jigging stroke's frequency. A water inlet attached to the pulsation housing allows water input into the apparatus. A pressured air buffer or expansion chamber mounted on the water inlet stores air and buffers water pressure, preventing water hammering in the pump supplying water to the jig.

An embodiment provides a jig concentrator that achieves optimized layering of light and heavy particles at a lower cost. This design allows for wider jigs while maintaining optimal stratification of light and heavy particles.

According to one embodiment, a jig concentrator includes a jigging bed installed in the apparatus to support heavy and light particles while allowing fluid (usually water) to flow through it. A flow control valve associated with the jigging bed controls the fluid flow, while a water pulsation housing connected to the flow control valve regulates water pulsation. A water inlet attached to the pulsation housing allows water input into the apparatus. A pressured air buffer mounted on the water inlet buffers and stores air in the apparatus.

Another specific embodiment features a jig concentrator with a jigging bed that has one or more holes, a flow control valve associated with the bed to control fluid flow, and a pulsation housing connected to the flow control valve to manage water or media pulsation. The valve is housed beneath the bed. A water inlet connected to the pulsation housing allows water input into the apparatus. A pressured air buffer mounted on the water inlet buffers and stores air. Multiple hutches form a longer jigging bed to store fluid and sort material. The pulsation housing is housed under the fluid inlet to independently control the fluid bypass. Pipes under the jig bed, equipped with holes, ensure even fluid distribution through the jigging bed. A punched screen plate connected to the bed supports the ragging material. Furthermore, several delivery pipes are attached to the hutch to input fluid into the jig. The concentrator has multiple chambers connected to the hutch, designed to collect heavy and light particles. Multiple slots associated with the delivery pipes ensure even jigging fluid delivery, optimizing material stratification in layers based on density.

Another embodiment describes a method for sizing and separating particles of a generally low-density material using a jig concentrator. The concentrator includes a stand, a frame, a jigging bed within the frame, and a flow control valve that restricts the fluid flow per unit of time to set the jigging stroke amplitude. A water pulsation housing linked to the flow control valve regulates water pulsation and determines the jigging stroke frequency. A water inlet connected to the pulsation housing allows water input into the apparatus. A pressured air buffer mounted on the water inlet stores air and buffers the water flow. This method involves operating a motor to generate the pulsation and suction motion and feeding material onto the jigging bed.

In another embodiment, the fluid used can be water or other media. In yet another embodiment, the fluid is air-free.

### BRIEF DESCRIPTION OF THE DRAWINGS

FIG. 1 illustrates a schematic view of one embodiment of the jig concentrator;

FIG. 2A shows a perspective view of an exemplary pulsation housing used in the embodiment shown in FIG. 1;

FIG. 2B shows a perspective view of another example of a pulsation housing used in the embodiment shown in FIG. 1;

FIG. 3 shows a schematic view of the jigging bed and water assembly;

FIG. 4 shows a bottom view of the jig, highlighting the slots in the pipes located beneath the jig bed, which are part of the fluid delivery system;

FIG. 5 shows a schematic view of the jig hutch; and

FIGS. 6A, 6B, and 6C illustrate examples of pulsation housings.

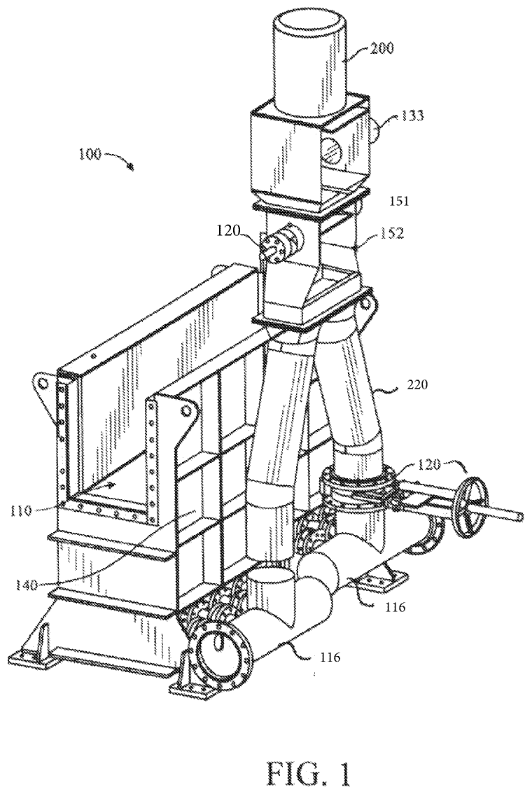

### DETAILED DESCRIPTION

FIG. shows one embodiment of the jig or jig concentrator 100, which includes a jigging bed 110 with one or more holes, a flow control valve 120 associated with the jigging bed 110 to control the flow of fluid through it, and a pulsation housing 150 connected to the flow control valve to control the pulsation of the fluid. The fluid inlet 133 is operatively connected to the water pulsation housing 150 to introduce water into the jig concentrator 100. Additionally, a pressurized air buffer or expansion tank 200 is mounted on the water inlet to buffer and store air or water in the apparatus. The jigging bed 110 can be a typical jigging bed used for density separation. Water headers 116 are visible and are offset and capped. Water flows through conduits 220.

Beneath the jigging bed 110 is a fluid or liquid distribution assembly (shown later) that contains one or more openings/slots for fluid release. The fluid can be water or another medium with a specific gravity. The jigging bed 110 holds material that can be stratified into heavy and light particles. The jigging bed 110 supports the layered heavy and light particles separated by differences in specific gravity. The jigging bed 110 is designed to allow fluid to be pulsed through it, driven by the pipes 185 (shown later). The jigging bed 110 can use a screen media, such as a punched screen plate, to support the light and heavy particles.

As seen, the jig concentrator 100 has a hutch or frame 140 with a jigging bed 110. The jigging bed 110 allows water to flow through the holes (shown later) in the bed to create pulsation and suction stroke motions. A flow control valve 120 associated with the jigging bed 110 controls fluid flow, restricting it per unit of time to establish the amplitude of the jigging stroke. The water pulsation housing 150, connected to the valve housing 152, controls the pulsation of water and determines the frequency and amplitude of the jigging stroke. The water inlet 133 attached to the water pulsation housing 150 enables the input of water or media in the jig concentrator. A pressurized air buffer or expansion chamber 200, mounted on the water inlet, buffers and stores air, ensuring adequate pulsation. In this embodiment, pulsing is created by the water or media flow without the need for air or other mechanical devices.

The jigging bed 110 may support a ragging material. The punched screen plate is a standard that provides sufficient open area to support an accurately sized material used as ragging material. The ragging material that attempts to pass through the openings of the jigging bed is retained on the bed 110.

The jigging bed 110 supports material, allowing it to react to the principle of jigging. Jigging is actuated by alternate strokes of pulsation and suction (flow and no flow). The material supported by the jigging bed 110 begins to dilate at the start of a pulsation stroke, separating particles through differential acceleration followed by free settling and hindered settling principles. A suction stroke helps stratify the material bed according to specific gravity and allows fine particles to trickle through the bed.

One or more flow control valves 120 are associated with the jigging bed 110. The flow control valve 120 regulates fluid flow to influence the amplitude of the jigging stroke. The flow control valves 120 may be fitted with actuators and position holders. Pneumatically actuated globe valves and diaphragm valves are widely used for control purposes in many industries, although quarter-turn types like ball and butterfly valves are also used. The flow control valves 120 can also work with hydraulic actuators and are known as hydraulic pilots. These types of valves are also known as automatic control valves. The flow control valves may also be manual. The hydraulic actuators respond to changes in pressure or flow and will open/close the valve. Automatic control valves do not require an external power source, as fluid pressure alone is enough to open and close them.

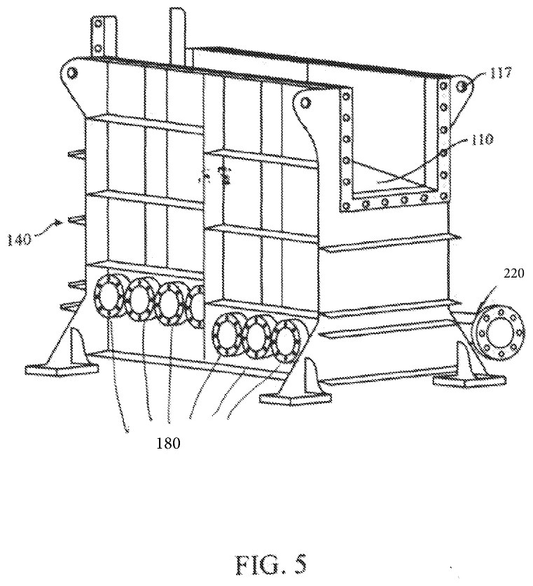

Referring to FIG. 5, multiple hutches 140 can be connected to form a jigging bed 110 for storing fluid and serving as a conduit for material discharge. The hutch 140 openings may or may not be fitted with valves. The frames can be connected through bolt holes 117 to elongate the frame or bed. The jig concentrator 100 and the fluid reservoir are all contained within a vessel, and the hutch 140 is filled with fluid. The hutch 140 can be a single unit or chamber or comprise multiple units or chambers. The chambers collect any material that finds its way below the hutch 140. Integrated into the jig concentrator 100, there may be a mechanism for separating feed material that has experienced jigging and rising current actions. The jigging bed 110 has holes, as those skilled in the art would understand.

A water pulsation housing 150 can be in fluid connection with the flow control valve 120 to control the pulsation and flow of water. The water pulsation housing 150 regulates the frequency of the fluid flow, typically water or another medium, to create the jigging stroke from a reservoir of pressurized fluid generated by a centrifugal, reciprocating, or peristaltic positive displacement pump. It regulates the acceleration and deceleration of the pumped fluid. This uncontrolled energy appears as pressure spikes, which can damage seals, gauges, diaphragms, valves, and piping joints. To avoid such damage, an air reservoir or expansion tank 110 can be included in the piping of the jig concentrator apparatus 100.

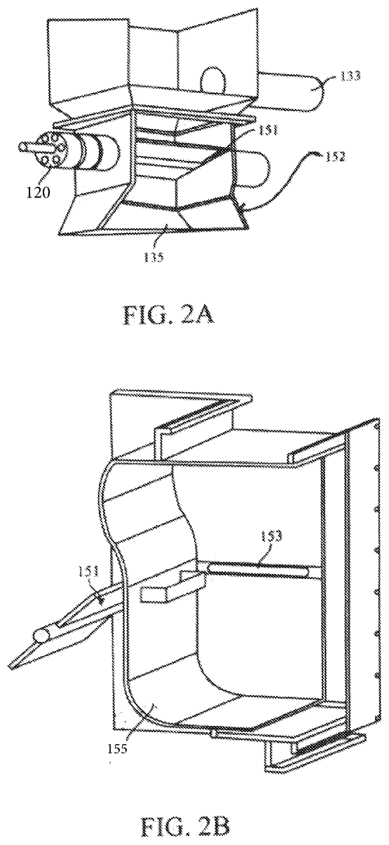

FIG. 2A and FIG. 2B show an exemplary pulsation housing 150 housed under the water inlet 133 to control, and if needed, bypass a portion of the fluid. The water inlet 133 allows water to flow in, and water exits through exit opening 135 of the valve housing 158. FIG. 2B shows half of the valve, and its mirror image is opposite the diaphragm 155. The pulsation housing 150 may also be referred to as a dynamic, severe flow control valve 150.

As shown in FIG. 2A and FIG. 2B, the pulsation housing 150 has a diaphragm 155 that allows for controlled bypass of the fluid, and the fluid inlet (not shown) is on the top portion to let water or media flow in. In one example, the adjustable housing 155 can slide along slide 153. A propeller 151 is attached to the adjustable housing through bearings 120, generating a disturbance in fluid flow. This severe disturbance of flow, from minimal to full flow, creates a jigging stroke within the jig hutch, which causes the particles to move in a jigging motion. The adjustable housing 152 may move horizontally with the fluid flow to allow more or less fluid to bypass the pulsation housing 150. The pulsation housing 150 can control the flow of water through a flexible hose, providing clearance to handle flows containing solid particulate matter, such as slurries. The valve body or housing or diaphragm 155 may be constructed from plastic, metal, or other materials, depending on the intended use.

The jig concentrator pulses the water upwards from the lower portion of the hutch 140. The water from beneath creates a vertical pulsation of water or rising current that is evenly distributed throughout the hutch 140 of the jig concentrator. This type of water motion provides advantages in particle stratification and economics. The water is controlled through the flow control valve 120 and flows in the direction of the hutch 140. A jigging stroke maintained by a reservoir of relatively high-pressure fluid from the pulsating delivery allows a release of a predetermined volume of fluid. The stroke may be a sinusoidal wave or a skewed sinusoidal wave.

The fluid reservoirs and pipes are under the jigging bed 110. In this arrangement, relatively equal amounts of fluid (water or media) are delivered from each outlet on the fluid reservoir. In this arrangement, the widths of jigging concentrators are no longer limited by the projection of a pressure wave, as is created by pulsed air forcing the movement of water. The intermittent and timed delivery of water under pressure into the jig hutch 140 occurs independent of air pulsations or mechanical devices that constrict the fluid volume inside the jig hutch 140.

A water inlet 133 is attached in fluid connection with the water pulsation 150 valve to input water into the apparatus 100. The water inlet 133 may fill the apparatus with water at a predetermined pressure. The width of the jigging bed 110 may be much wider. The water flows from the inlet.

FIG. 4 shows a bottom view of the jigging bed 110 and hutch 140, which can have one or multiple slots 180 associated with delivery pipes 185 to separate the material. The slots 180 maintain the original strength of the delivery pipe 185 and provide more uniform fluid distribution. The slots on the bottom can be used to avoid particle buildup where the water is dirty, or the media is thicker. There may be one or multiple slots 180 in the delivery pipes 185.

Referring to FIG. 4, multiple fluid inlets 165 conserve the fluid in the apparatus 100. The pulsating action of the fluid may be projected within reasonable geometric limitations. The pulsating source may be limited by the reservoir volume. Multiple fluid inlets 165 conserve the fluid in the apparatus 100. The pulsating action of the fluid may project without reasonable geometric limitations. The pulsating source may be limited by the reservoir volume connected to the water headers 116.

The jig concentrator may have a 40-foot-wide jigging bed with an even jigging stroke across the full width. Specifically, the jig is of increased effectiveness due to the more efficient jigging stroke achieved by introducing fluid into the hutch 140 with relatively independent control of the amplitude, frequency, and acceleration of the stroke.

A pressurized air buffer 200 is mounted on the water inlet 133 to buffer and store air in the apparatus 100. The pressurized air buffer 200 acts as a buffer and a variable storage medium for the water inlet 133. The pressurized air buffer 200 will modulate its capacity during normal operation as water is consumed and replenished in the water reservoir 116.

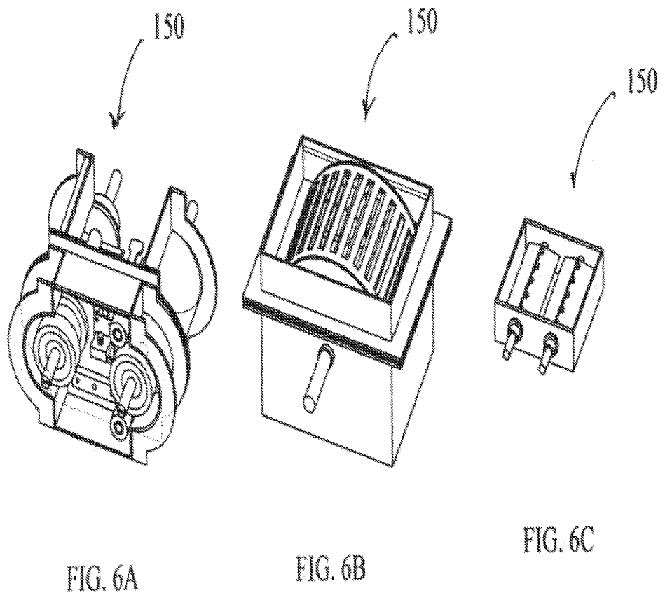

As shown in FIGS. 6a, 6b, and 6c, there can be multiple types of pulsation housings 150 known and developed in the future.

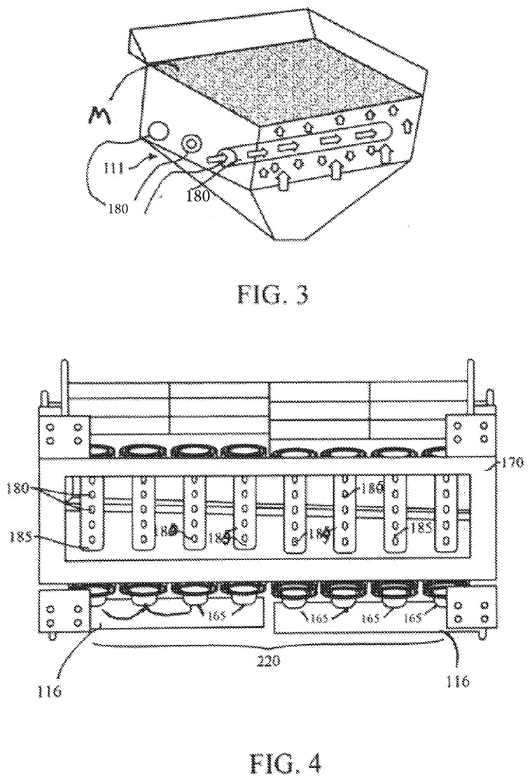

Referring to FIG. 3, a schematic drawing, the jig concentrator 100 provides an optimal jigging stroke with a pulsating rising current. The ideal jigging stroke is based on specific gravity, which is also known as gravity separation. Gravity separation uses the density of particles in fluid. Pulsating water with controlled alternating pressure enters the apparatus through the water inlet 133. The water that enters the jig is slurry, which separates the heavy and light particles due to gravity separation. The water rises on the jig bed through a screen called perforated plates, which are made from urethane. Material M can be separated.

Multiple hoppers can be connected to the hutch 140 for collecting any heavy and light particles discharged below the material support device. The hopper is a large, pyramidal-shaped container used in processes to hold particulate material that has collected from expelled fluid, discharged through the material support device, or separated by mechanisms installed to separate high-density particles from lower-density particles. The hoppers are usually installed in groups to allow for greater collection quantity. The hopper walls are insulated to protect the outside environment and personnel from the discarded contents.

In operation and use, or as schematically shown in FIG. 3, water or media in the jig concentrator 100 pulses upwards from beneath the hutch or jigging bed 110 through one or more pipes with holes or slots. The water from beneath creates a vertical pulsation of water or rising current, which is released along the walls of the hutch of the jig concentrator. This type of water motion provides advantages in particle stratification and the economics of material M. Water or media can be controlled through a typical flow valve and can flow along the direction of the arrowed line in the hutch or bed. This embodiment can achieve a jigging stroke by maintaining a reservoir of relatively high-pressure fluid, primarily water, from which a pulsating delivery system allows the release of a predetermined volume of fluid, or through the use of a pulsating pump. The resulting action on particles located on a jigging bed is the same. The pulsation can be created by media, water, or air-free fluid.

FIG. 4 shows a bottom view of the jigging bed 110 of jig concentrator 100 on frame 170, which can have multiple slots 180 associated with delivery pipes 185 for separating material. The slots 180 keep the original strength of the delivery pipe 185 and provide more uniform distribution of fluid. The slots on the bottom can be used to avoid particle buildup where the water is dirty or the media is thicker. The slots 180 also separate the heavy particles that may be entrained with the jigging fluid (e.g., media or water).

Another embodiment includes a method of sizing and separating particles of a generally low-density material using a jig concentrator, which comprises a stand, a frame, and a jigging bed in the frame on the stand. The jigging bed allows the water to flow through the holes in the jig bed to create pulsation and suction stroke motion. A flow control valve 120 associated with the jigging bed controls the fluid flow, restricting it per unit of time to establish the amplitude of the jigging stroke. A water pulsation housing 150 connected to the flow control valve 120 controls the pulsation of water and determines the frequency of the jigging stroke, and a water inlet attached to the water pulsation housing 150 allows input of water in the apparatus. A pressurized air buffer is mounted on the water inlet to buffer and store air in the apparatus. The steps include actuating a motor for imparting the pulsation and suction motion and supplying material onto the jigging bed.

Another embodiment includes a jig powered by motion and gears, similar to other jigs known to those skilled in the art. Methods and systems can include actuating a motor for imparting the pulsation and suction motion and supplying material onto the jigging bed.

One embodiment includes a jig that is not a Baum Jig and does not use air to set water into a jigging stroke motion. In such embodiments, certain designs do not include diaphragms or mechanical levers or plungers to set water into a jigging stroke motion. These embodiments allow a pulsation housing to control the flow of only water to create a jigging stroke motion. In doing so, the design can create an even jigging stroke across the width of the jigging machine, resulting in a wider jigging bed than those of typical Baum or mechanical jigs.

The light and heavy particles are separated by the jig concentrator 100 without consuming long hours. Moreover, the metal is separated from the material stream. The effectiveness of the jigging in the bed of liquid can be varied accordingly. The valves and liquid flow are arranged so that the forces in the jigging bed 110 are effective.

As can be seen, the terms “heavier” and “lighter” refer to relatively greater and lesser specific gravity, respectively. Within the separation, absolute weight can be less important than buoyancy in the fluid. The light and heavy particles are separated by the jig concentrator 100 without consuming long hours. Moreover, the metal is separated from material stream. The effectiveness of the jigging in the bed of liquid can be varied accordingly. The valves and liquid flow so that the forces in the jigging bed 110 are effective.

Although the field of the invention has been described herein with limited reference to specific embodiments, this description is not meant to be construed in a limiting sense. Various modifications of the disclosed embodiments, as well as alternate embodiments of the invention, will become apparent to persons skilled in the art upon reference to the description of the invention.

1. A jig concentrator, comprising:
a jigging bed that is elongated, configured to support material during separation, and designed to allow fluid to pass through;
a plurality of pipes positioned underneath the jigging bed to ensure consistent distribution of fluid across the jigging bed, wherein the pipes have slots that enable the fluid to pulse through to the bed;
a flow control valve associated with the jigging bed, configured to regulate the flow and pressure of the fluid to manage the pulsation frequency;
a pulsation housing connected to the plurality of pipes, designed to regulate the flow of the fluid and equipped with a diaphragm to control the pulsing of the fluid entering the plurality of pipes;
a water inlet operatively connected to the pulsation housing, enabling the flow of fluid into the jig concentrator through water headers for uniform distribution; and
a pressurized air buffer connected to the fluid inlet, designed to store and release air to maintain consistent pressure during the pulsation process, thereby aiding in efficient material separation.

2. The jig concentrator of claim 1, wherein the jigging bed has multiple holes that allow water to permeate, generating pulsation and suction stroke motions along the jigging bed; and wherein the pulsation housing modulates fluid flow, establishing the jigging stroke's amplitude.

3. The jig concentrator of claim 1, wherein the pulsation housing is configured to adjust the frequency and amplitude of the fluid pulsations to optimize the separation of materials based on their specific gravities.

4. The jig concentrator of claim 1, wherein the pulsation housing, situated beneath the fluid inlet, operates independently to manage fluid bypass.

5. The jig concentrator of claim 1, wherein a punched screen plate is affixed to the jigging bed to support material.

6. The jig concentrator of claim 2, wherein multiple chambers are connected to a hutch, enabling collection of both heavy and light particles.

7. The jig concentrator of claim 2, characterized by multiple slots in conjunction with delivery pipes to promote consistent fluid delivery and optimize material stratification based on density.

8. The jig concentrator of claim 1, wherein the jigging bed has a screen.

9. The jig concentrator of claim 1, wherein the plurality of pipes are connected to a conduit, and the conduit is connected to the pulsed fluid source.

10. The jig concentrator of claim 1, wherein the fluid is a medium.

11. A method for separating material using a jig with a jigging bed, comprising:
a) introducing material onto the jigging bed, wherein the jigging bed is elongated;
b) providing pulsated fluid through the jigging bed using a plurality of pipes with slots spread along the jigging bed, wherein the fluid flows through the slots;
c) sorting the material using the pulsed fluid such that heavy and light material separate by specific gravity; and
d) gathering the heavy and light materials.

12. The method of claim 11, wherein the jig concentrator includes a stand, a frame, and the jigging bed.

13. The method of claim 11, wherein the plurality of pipes with slots allow fluid to flow through the jigging bed to produce pulsation.

14. The method of claim 11, wherein the jigging bed is angled to facilitate separation.

15. The method of claim 11, wherein the plurality of pipes are connected to a conduit, and the conduit is linked to a source of pulsed fluid.

16. The method of claim 11, wherein the fluid is delivered in pulses through a pulsation stroke.
